(19) United States
(12) Patent Application Publication
(10) Pub. No.: US 2008/0109246 A1
(43) Pub. Date: May 8, 2008

(54) Method for Cooperative transport of parcels

(76) Inventor: Mark C. Russell, Spokane, WA (US)

Correspondence Address: LEE & HAYES, PLLC, 421 W. RIVERSIDE AVE, STE 500, SPOKANE, WA, 99201, US

(21) Appl. No.: 11/935,373

(22) Filed: Nov. 5, 2007

Related U.S. Application Data
(60) Provisional application No. 60/856,789, filed on Nov. 6, 2006.

(51) Int. Cl. G06Q 10/00

(52) U.S. Cl. 705/1; 414/800

(57) ABSTRACT

The system and methods disclosed allow cooperative transport of parcels by aggregating excess carrying capacity of participating individual transport agents planning on or actually engaging in travels. Parcels are accepted at a sorter where a transport agent, who is traveling generally in the direction the parcel needs to go, picks it up and carries it along to the next sorter. This process continues until the parcel arrives at the sorter closest to the final destination. This aggregation increases utilization efficiency of available modes of transport and results in many benefits including: saving energy by reducing overall fuel usage, decreasing overall vehicular pollution generation and congestion, and reducing wear and tear on transportation infrastructure.

### RELATED APPLICATION

The present application claims priority to and is related to U.S. Provisional Application Ser. No. 60/856,789, entitled, “Network for Fast Delivery of Packages and Computer System and Method for Automated Delivery Control”, to Mark C. Russell, filed on Nov. 6, 2006; which is incorporated by reference herein for all that it teaches and discloses.

### BACKGROUND

The subject matter relates generally to the delivery of parcels, and more specifically the cooperative use of excess capacity present in existing transportation modes. Traditional parcel delivery systems require the use of dedicated vehicles and individuals, resulting in increased energy usage and wear-and-tear on transportation infrastructure. Existing systems fail to take advantage of excess capacity available in transportation systems, such as space in the private vehicles of commuting individuals, bicycles, pedestrians, public transit, private carriers, and the like. Furthermore, these systems do not bind together the individual abilities of a group sufficient to form a viable parcel transportation network.

### Terms and Definitions

A customer is a person or an entity who has parcels to ship.

A parcel is an item that requires transport, including, but not limited to, packages, goods, people, energy, fuels, and the like.

Environmental factors include, but are not limited to, weather, traffic data, size of parcel, parcel contents, sorter information, sorter availability, location of sorters, capacity available at sorters, sorter capabilities, transport agent profile, dynamic changes in transport agent availability, ad-hoc changes in route by transport agents, source of parcel, destination of parcel, geographic information, insurance availability, and the like.

A leg is a path between two points.

A sorter is a transfer point for parcels, which may be automated, manual, or both. Parcels may be held at a sorter while awaiting the next transport agent or immediately handed off. The hand off may even be back to the depositing transport agent to facilitate the method including, but not limited to, scanning a parcel for undesirable contents, parcel tracking, when a sorter is full, and the like. Sorters may be in communication with a controlling system. Sorter locations may include, but are not limited to, dedicated shops, coffee shops, bookstores, malls, automated kiosks, post offices, restaurant drivethroughs, bank drivethroughs, cubbyholes in convenient public transit stations, individuals, and the like.

A transport agent includes, but is not limited, to an individual who maintains a transport agent profile and carries parcels from a location to another location. The individual may be compensated for his or her actions. The individual may be a business agent, an independent contractor, or an employee. The transport agent may also be another entity such as a corporation, a partnership, autonomous vehicle, remotely directed vehicle, robot, and the like.

A transport agent profile contains parameters about that agent including, but not limited to, data comprising fuel efficiency of a vehicle, travel schedule, availability, current location, willingness to deviate from usual route, fees, bidding ranges, past performance data, vehicle capability, transport agent willingness to deviate from his or her planned path, customer willingness to deviate from his or her planned path, recipient willingness to deviate from his or her planned path, previous performance rating, rating from customers, actual performance data, and the like.

A delivery agent is a special transport agent who is authorized to deliver directly to a recipient.

A delivery outcome statistic includes, but is not limited to, energy efficiency of a leg, energy efficiency of the overall route, probability of delivery, estimated time of delivery, probability associated with a particular delivery time or date, costs associated with the routes presented, path length, aggregate delivery costs, and the like.

A requester is a party who wishes to see a delivery outcome statistic, and includes, but is not limited to, a customer, a recipient, a transport agent, and the like.

A communications network includes, but is not limited to, a landline telephone network, a landline data network, a cellular telephone network, a cellular data network, a satellite system, a terrestrial wireless, a wi-fi, a wireless network, a free space optical system, internet, and the like.

The term ad-hoc used in this application means a degree of autonomy remains with the transport agents who may independently choose to take an action. That action could be purposeful or random. For example, in such an ad-hoc system, a user might stop by the sorter in his or her neighborhood in the morning and see if a parcel is destined for a sorter near his or her workplace. If so, he or she may transport the parcel between the two sorters.

A parameter is any of a set of properties whose values describe the characteristics or behavior of something.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 shows an exemplary flow of multiple parcels in a cooperative transport system through a series of sorters.

FIG. 2 is a flow diagram of an exemplary cooperative transport method.

FIG. 3 is a block diagram showing an exemplary system for implementing the cooperative transport method.

FIG. 4 shows a single package in transit in an exemplary cooperative transport system.

### DETAILED DESCRIPTION

Overview

Disclosed herein is a method for cooperative transport of parcels by aggregating excess carrying capacity of participating individual transport agents. The transport agents transport the parcels by engaging in their travels.

Transport agents may act in an ad-hoc fashion, picking up parcels as they engage in their usual travels and depositing the parcels at sorters. Alternatively, transport agents may be actively directed by a controlling system which may be manual or automated using a controlling computer system. This computer system may direct the transport agents by using well-known conventional routing algorithms, or utilize such methods including, but not limited to, neural networks, heuristic networks, collective intelligence, systems intelligence, distributed cognition, swarm intelligence, and the like. The controlling system is also capable of responding to the ad-hoc nature of the transport agents themselves and the dynamic environment in which the transport agents operate. For example, if a transport agent's route was redirected due to a new accident immediately ahead and deposited a parcel in a sorter different then directed, the controlling system would then re-route the parcel to accommodate this change. The transport agent may be directed not only by the controlling system but by himself or herself as well. Communication between the transport agent and the controlling system creates the cohesive cooperative delivery method.

In the case of an actively directed system, the controlling computer system can dynamically adjust proposed and active routes in response to environmental factors.

Incentives and compensation may be provided to transport agents. These incentives include, but are not limited to, payment for transport, transport credits, carbon credit offsets, and the like. Incentives may be distributed on a flat “per transport” basis, or through bidding. Partial or full compensation to a transport agent may be paid at various points in the process including, but not limited to, upon deposit at sorter, payment at a specified interval after deposit at sorter, after delivery to recipient, payment at a specified interval after delivery to recipient, before transport, and the like.

Such bidding may use parameters in the transport agent profiles, including but not limited to, maximum amount of deviation from the transport agent's normal route, proximity to sorters, past customer ratings of transport agent, length of route, leg endpoint location, hours of availability, capacity, minimum amount to charge for carrying a parcel, traffic conditions, and the like. The controlling computer system and routing software analyzes factors, such as the proposed route, transport agent profile and environmental factors to assemble a composite bid to the customer. This analysis includes incorporating the bids for each leg's suitable transport agents, giving one or more options for cost, schedule and reliability. The customer may either choose from the available options or give a maximum price and allow the controlling computer system to choose a best value. A suitable option is then accepted as an active delivery route. Alternatively, a parcel could be accepted for shipment before bidding and determination of an active route. For example, on a route with many available transport agents, the shipment request could be submitted, then accepted, then the bidding and active route determined.

A performance of the transport agent is monitored and considered in the analysis during the route determination, bidding process, to provide rating information to customers, and the like. For example, a constantly reliable and quick transport agent with high customer ratings might command a premium bid.

A delivery outcome statistic may also be generated. Once generated, this may be presented to a customer or other user. This delivery outcome statistic may include, but is not limited to, delivery cost, expected delivery time, probability of success, and the like. The delivery outcome statistic may be presented to the user to facilitate a choice from possible delivery options. The delivery outcome statistic may also be used by the system to select an optimal routing.

The method may also involve interactively communicating with transport agent(s) or delivery agent(s). The transport agent may be queried about accepting a bid which matches his or her profile, or which was automatically accepted on his or her behalf. The transport agent can then decide whether the requested portion of the delivery route is acceptable for the requested price and timing and the transport agent can electronically send that information back to the controlling system for confirmation of acceptance or denial of request. If the transport agent failed to respond, the system could consider that non-acceptance of carry. The transport agent may also be re-directed to deal with changes in environmental factors.

The method may also involve communication between sorters and the controlling system. Such communication includes, but is not limited to, operational status, capacity, current inventory of parcel, tracking information for the parcels, number of users in queue to use the sorter, whether a sorter should accept parcels not directed to it, and the like.

The transport agent or delivery agent may transport several parcels at any one time to the same or different recipients. Just as parcels may be accepted by sorters, parcels may also be picked up by delivery agents.

The method not only utilizes existing transportation capacity, but has the potential to affect traffic in the transportation network as well. For example, early morning parcels may bid to higher prices, encouraging commuters to leave for work early and thus reducing traffic congestion. Thus, as participation increases, there could be benefits to municipalities to participate in the system to actively manage the traffic flows in the municipalities.

The method may also be interfaced with existing conventional package delivery services. For example, a conventional delivery service could inject their parcels into the parcel stream thus providing delivery to customers throughout the day, rather then using their own trucks at their normal routing intervals. A conventional delivery service may also be utilized to provide services such as long haul transport, while this invention is used for the collection and distribution at the respective ends. This combination leads to optimal utilization of each method's strengths.

The method may also provide for insuring the parcels. Such insurance may be for the entire route, or on a per leg basis.

This method is applicable to human traffic as well. Participants can more efficiently carpool and access excess capacity on multiple transportation modes, including public and mass transit system. This could help alleviate several shortcomings present in the existing discrete transportation networks. For example, take the bus rider who works late: The bus rider misses the last bus and might be stranded or require a special trip by someone else to pick him or her up or an expensive dedicated taxi ride. Using this invention, he or she is able to find a fellow traveler heading towards the same direction for an affordable cost. In this scenario, the sorters may simply be designated meeting points, such as a coffee shop.

The techniques described herein may be implemented in a number of ways. One example environment and context is provided below with reference to the included figures and on going discussion.

Exemplary Method

Specifics of exemplary methods are described below. However, it should be understood that certain acts need not be performed in the order described, and may be modified, and/or may be omitted entirely, depending on the circumstances. Moreover, the acts described may be implemented manually or by a computer, processor or other computing device based on instructions stored on one or more computer-readable media. The computer-readable media can be any available media that can be accessed by a computing device to implement the instructions stored thereon.

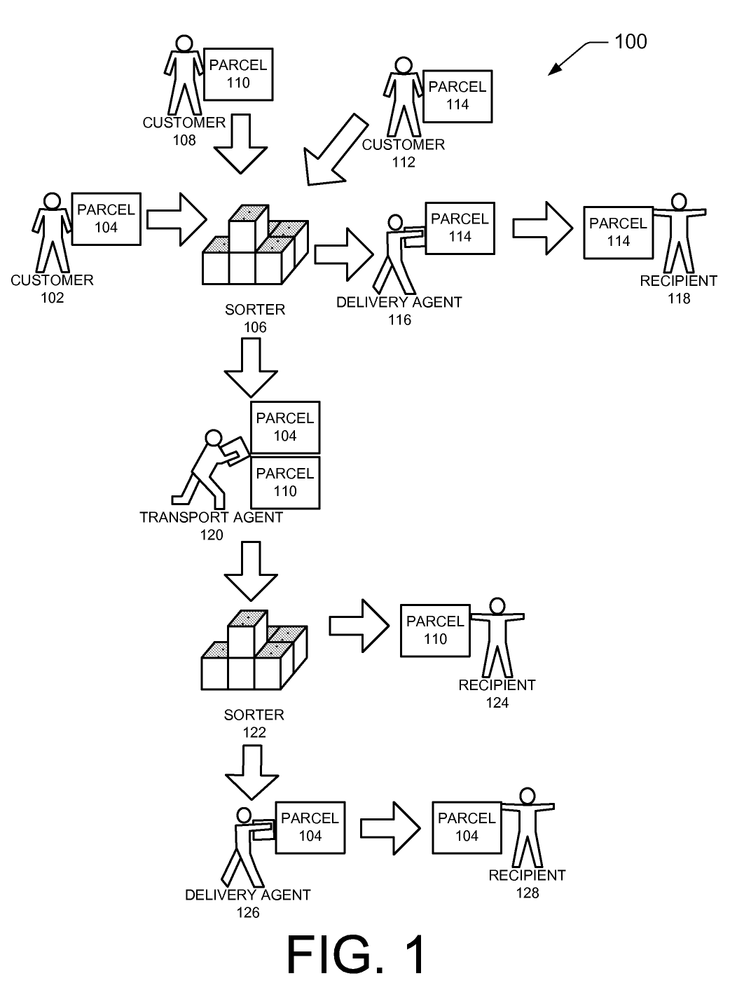

FIG. 1 illustrates one implementation of an exemplary cooperative delivery method using multiple sorters 100. A first customer 102 has parcel 104 for delivery to recipient 128, and deposits the parcel at his nearest sorter, 106. A second customer 108 has parcel 110 for delivery to recipient 124, and deposits the parcel at his nearest sorter, 106. A third customer 112 has parcel 114 for delivery to recipient 118, and deposits the parcel at his nearest sorter, 106.

One delivery agent 116 takes parcel 114 to recipient 118. Another transport agent 120 is traveling between sorter 106 and sorter 122, and takes parcels 104 and 110, dropping them off at sorter 122. Recipient 124 is going by sorter 122, and picks up parcel 110 himself. Another delivery agent 126 takes parcel 104 and delivers parcel 104 to recipient 128.

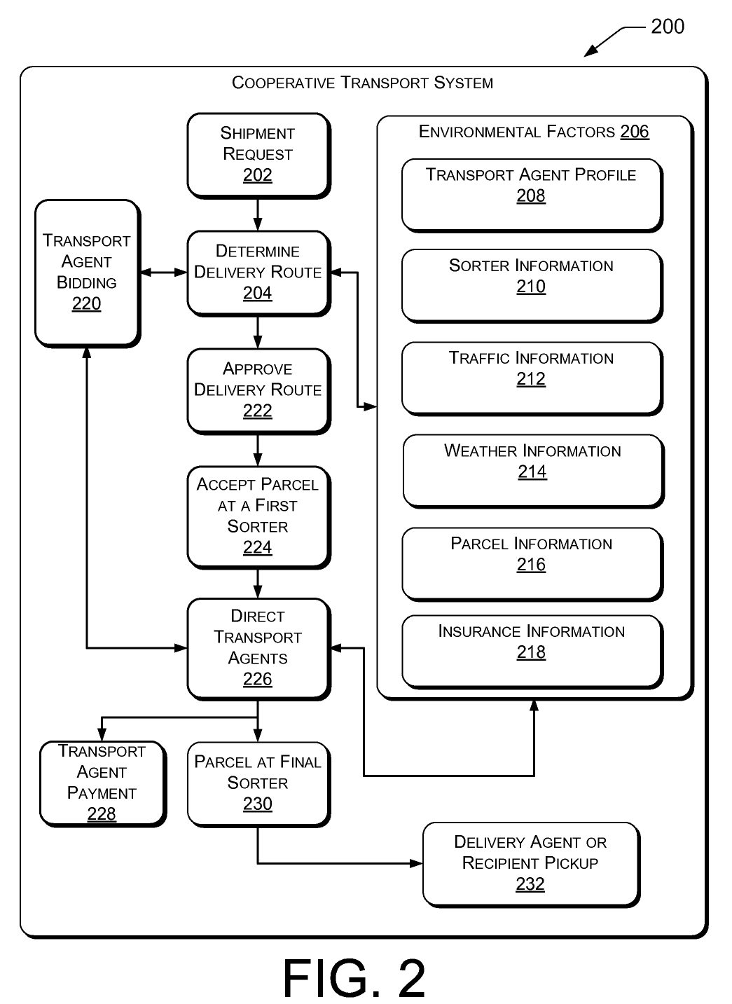

FIG. 2 is a flow diagram illustrating one implementation of a cooperative transport system 200. A shipment request 202 from a customer is received by the system 200. A delivery route 204 is then determined based on environmental factors 206 at that time. These factors may include, but are not limited to, the transport agent profiles 208, information about the sorters 210, traffic information 212, weather information 214, parcel information 216, insurance information 218, and the like. Each leg of the route may be placed for bidding 220 and this information incorporated into the determination of delivery route 204. Bidding systems are well known in the art and need not be discussed at length here.

Once the route is approved 222, the parcel is accepted at a first sorter 224. The transport agents are then directed to carry the parcel along the active delivery route taking into account environmental factors 226. As legs are completed, payment is accrued by the transport agents 228. Environmental factors 206 may result in changes to the active delivery route. If the active delivery route is changed, the legs of the new active delivery route may be placed for bid 220. Once a parcel arrives at the final sorter 230, a delivery agent may deliver or the recipient may pickup 232.

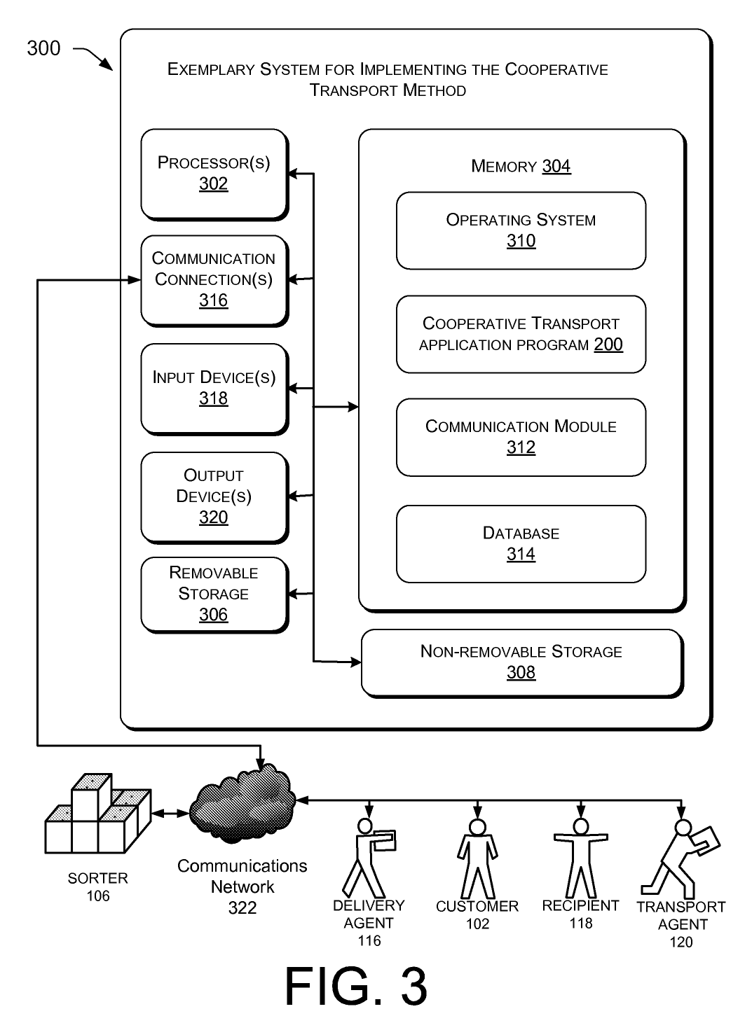

FIG. 3 is a schematic block diagram of an exemplary general operating system 300. The general operating system 300 may be configured as any suitable system capable of implementing the cooperative transport system of 200. In one exemplary configuration, the general operating system 300 comprises at least a processor 302 and memory 304. The processing unit 302 may be implemented as appropriate in hardware, software, firmware, or combinations thereof. Software or firmware implementations of the processing unit 302 may include computer- or machine-executable instructions written in any suitable programming language to perform the various functions described.

Memory 304 may store programs of instructions that are loadable and executable on the processor 302, as well as data generated during the execution of these programs. Depending on the configuration and type of computing device, memory 304 may be volatile (such as RAM) and/or non-volatile (such as ROM, flash memory, etc.). The system may also include additional removable storage 306 and/or non-removable storage 308 including, but not limited to, magnetic storage, optical disks, and/or tape storage. The disk drives and their associated computer-readable media may provide non-volatile storage of computer readable instructions, data structures, program modules, and other data for the communication devices.

Turning to the contents of the memory 304 in more detail, may include an operating system 310, cooperative transport application programs 200 for implementing all or a part of the cooperative delivery method. For example, the general operating system 300 illustrates architecture of these components residing on one system or one server. Alternatively, these components may reside in multiple other locations or be distributed across servers, devices, or systems. For instance, all of the components may exist on a client side. Furthermore, two or more of the illustrated components may combine to form a single component at a single location.

In one implementation, the memory 304 includes the cooperative transport system 200 as implemented as an application program, a communication module 312, and a database module 314. The communication module 312 communicates with transport agents, sorters, outside information sources to provide environmental factors, and may communicate with one or more local and/or remote databases or services. The database module 314 handles storage of data for the applications on the general operating system 300.

Computer storage media includes volatile and nonvolatile, removable and non-removable media implemented in any method or technology for storage of information such as computer readable instructions, data structures, program modules or other data. Memory 304, removable storage 306, and non-removable storage 308 are all examples of computer storage media. Additional types of computer storage media that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by users.

The general operating system 300 may also contain communications connection(s) 316 that allow processor 302 to communicate with servers, the user terminals, and/or other devices on a network. Communications connection(s) 316 is an example of communication media. Communication media typically embodies computer readable instructions, data structures, and program modules. By way of example, and not limitation, communication media includes wired media such as a wired network or direct-wired connection, and wireless media such as acoustic, RF, infrared and other wireless media. The communication connections 316 may be connected a communication network 322 to provide communication to sorters 122, delivery agents 116, customers 102, recipients 118, transport agents 120, and the like. The term computer readable media as used herein includes both storage media and communication media.

The general operating system 300 may also include input device(s) 318 such as a keyboard, mouse, pen, voice input device, touch input device, etc., and output device(s) 320, such as a display, speakers, printer, etc. All these devices are well known in the art and need not be discussed at length here.

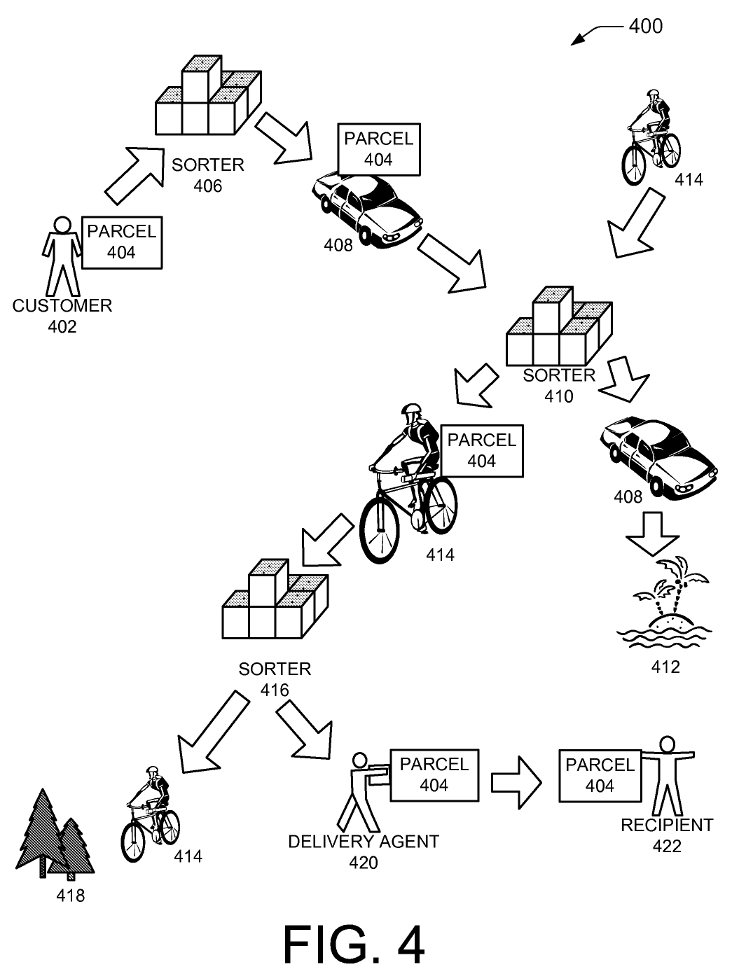

FIG. 4 illustrates one implementation of a cooperative transport method for a single parcel 400. Customer 402 has a parcel 404 for a recipient, and deposits the parcel 404 at his nearest sorter, 406. Transport agent 408 picks up parcel 404 from sorter 406 and deposits it with another sorter 410. As shown, transport agent 408 then continues on to his vacation 412.

Shown at the upper right of FIG. 4, is transport agent 414, who is on a biking trip and will go past sorters 410 and 416, so she picks up parcel 404 from sorter 410 and deposits it with sorter 416. Transport agent 414 then continues on to her destination 418.

Delivery agent 420 takes parcel 404 from sorter 416 to recipient 422 which is the final destination or completion of the delivery route for the parcel 404. This implementation is meant to serve only as a non-limiting example.

The subject matter described above can be implemented in hardware, or software, or in both hardware and software. Although embodiments of the cooperative delivery method have been described in language specific to structural features and/or methodological acts, it is to be understood that the subject matter defined in the appended claims is not necessarily limited to the specific features or acts described above. Rather, the specific features and acts are disclosed as exemplary forms of exemplary implementations of cooperative delivery. For example, the methodological acts need not be performed in the order or combinations described herein, and may be performed in any combination of one or more acts.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. For example, the system described could be configured as totally automated using real-time direction and tracking with fully automated sorters or as a totally manual operation.

1. A system for cooperatively delivering a parcel, comprising:
maintaining a plurality of transport agents;
receiving a shipment request from a customer;
determining a delivery route comprising one or more legs for the shipment request;
approving a delivery route as an active delivery route;
accepting the parcel at a first sorter;
directing the plurality of transport agents, wherein the transport agent carries the parcel between sorters in the active delivery route ultimately to a last sorter; and
delivering the parcel from the last sorter to a destination comprising at least one of a delivery agent or pickup by a recipient.

2. The system of claim 1 wherein determining the delivery route among the transport agents comprises bidding for the transport of a leg.

3. The system of claim 2, wherein the bidding for the transport of a leg in the route among the transport agents may be completed using a parameter in a transport agent profile.

4. The system of claim 1, wherein determining the delivery route is based on an environmental factor.

5. The system of claim 1, wherein the active delivery route is modified to reflect changes in an environmental factor.

6. The system of claim 1, further comprising generating a delivery outcome statistic.

7. The system of claim 6, further comprising presenting the delivery outcome statistic information to a requestor.

8. The system of claim 1, further comprising modifying a transport agent compensation based on a parameter in a transport agent profile.

9. The system of claim 1, wherein the determining of delivery routes is performed comprising at least one of a neural network, a heuristic network, a collective intelligence, a systems intelligence, a distributed cognition, or a swarm intelligence.

10. The system of claim 1, wherein the directing the plurality of transport agents utilizes a communications network.

11. A computer-readable storage media containing computer-executable instructions, implemented at least in part by a computing device, the computer-executable instructions comprising:
maintaining a plurality of transport agents;
receiving a shipment request for a parcel from a customer;
determining a delivery route comprising one or more legs for the shipment request;
approving a delivery route as an active delivery route;
accepting the parcel at a first sorter;
directing the assigned transport agent to carry the parcel between sorters in the active delivery route; and
delivering the parcel from a last sorter to a destination comprising at least one of a delivery agent or pickup by a recipient.

12. The computer-readable storage media of claim 11, wherein determining the delivery route is based on an environmental factor.

13. The computer-readable storage media of claim 11 wherein determining the delivery route among the transport agents comprises bidding for the transport of a leg.

14. The computer-readable storage media of claim 13, wherein the bidding for the transport of a leg in the route among the transport agents may be completed using a parameter in a transport agent profile.

15. The computer-readable storage media of claim 11, wherein the active delivery route is modified to reflect changes in an environmental factor.

16. The computer-readable storage media of claim 11, further comprising generating delivery outcome statistics.

17. The computer-readable storage media of claim 16, further comprising presenting the delivery outcome statistic information to a requestor.

18. The computer-readable storage media of claim 11, further comprising modifying transport agent compensation based on the parameters in the transport agent profile.

19. The computer-readable storage media of claim 11, wherein the directing the plurality of transport agents utilizes a communications network.

20. A method for cooperatively transporting a parcel, comprising:
accepting the parcel at a first sorter;
utilizing a transport agent in an ad-hoc arrangement to carry the parcel between sorters; and
depositing the parcel at a last sorter proximate to the parcel's destination.
